(19) United States
(12) Patent Application Publication
(10) Pub. No.: US 2009/0197036 A1
(43) Pub. Date: Aug. 6, 2009

(54) Wood Flooring With Laminated Wood And HDF Using Symmetric Structure And Process For Manufacturing The Same

(75) Inventors: Sung-chul Hwang, Chungcheongbuk-do (KR); Jae-Wan Sung, Chungcheongbuk-do (KR); Seung-Baik Nam, Chungcheongbuk-do (KR); Seung-Hun Lee, Chungcheongbuk-do (KR); Jong-Bum Kim, Jeollabuk-do (KR); Bum-Soo Kim, Chungcheongbuk-do (KR)

Correspondence Address: CANTOR COLBURN, LLP, 20 Church Street, 22nd Floor, Hartford, CT, 06103, US

(73) Assignee: LG CHEM, LTD., Seoul, Youngdungpo-gu (KR)

(21) Appl. No.: 11/628,527

(22) PCT Filed: Jul. 25, 2006
(86) PCT No.: PCT/KR2006/002923

§ 371 Date: Nov. 30, 2006

(30) Foreign Application Priority Data
Jan. 26, 2006 (KR) 10-2006-0008034

(51) Int. Cl. B32B 3/06; B32B 27/40; B32B 38/04; B32B 21/08; B32B 21/04; B32B 37/12

(52) U.S. Cl. 428/99; 428/413; 428/425.1; 428/481; 428/514; 428/479.6; 428/537.1; 156/60; 156/250

(57) ABSTRACT

Disclosed is a wood flooring containing laminated wood and high-density fiberboard using a symmetric structure and a process for manufacturing the same. The wood flooring includes a high-density fiberboard core layer and an upper laminated wood layer and lower laminated wood or veneer layer symmetrically stacked about the high-density fiberboard core layer to achieve a stable structure, and the lower laminated wood or veneer layer has a density of 100±30% of that of the upper laminated wood layer to keep the balance therebetween. With this configuration it is possible to completely eliminate deformation problems caused by variation of environmental conditions such as temperature, humidity, etc., and to impart the natural texture of raw lumber and high durability to the flooring surface.

This application claims the benefit of the filing date of Korean Patent Application No. 10-2006-0008034 filed on Jan. 26, 2006 in the Korean Intellectual Property Office, the disclosure of which is incorporated herein in its entirety by reference.

### TECHNICAL FIELD

The present invention relates to a wood flooring containing a laminated wood and high-density fiberboard using a symmetric structure and a process for manufacturing the same. More particularly, the present invention relates to a wood flooring which comprises a high-density fiberboard core layer and an upper laminated wood layer and lower laminated wood or veneer layer symmetrically stacked at upper and lower sides of the high-density fiberboard core layer to achieve a stable structure, the lower laminated wood or veneer layer having a density of 100±30% of that of the upper laminated wood layer to keep the balance therebetween, thereby completely eliminating deformation problems caused by variation of environmental conditions such as temperature, humidity, etc., and imparting the natural texture of raw lumber and high durability to the flooring surface.

### BACKGROUND ART

A conventional wood flooring for an under-floor heating system, which is manufactured by stacking a natural laminated wood over a water-resistant plywood and performing a surface coating treatment, has advantages, such as maximized natural texture of raw lumber and an outstanding dimensional stability against heat and moisture obtained through the use of the water-resistant plywood. However, due to a density of the water-resistant plywood as low as 600˜800 kg/m³ as well as a low density of the laminated wood itself, a surface of the conventional wood flooring exhibits scratch-resistance as low as 0.5˜3.0N and impact-resistance as low as 10˜20 cm despite of the presence of the surface UV coating. The scratch resistance is measured by scratching the flooring surface using a diamond chip, and the impact resistance is measured by dropping a metal ball weighing 225 g onto the flooring surface. Accordingly, the conventional wood flooring may be damaged when carelessly dropping heavy or sharp household appliances, or dragging heavy things thereon, and have a problem of causing the loss of energy due to a low heat conductivity thereof.

On the other hand, a conventional laminate wood flooring, which is manufactured by laminating a printing layer and melamine-impregnated overlay sheet at an upper side of a high-density fiberboard (HDF) layer and laminating a balance layer at a lower side of the HDF layer, has a higher surface strength than the above described wood flooring for an under-floor heating system containing the water-resistant plywood. However, due to the fact that a thermosetting melamine resin is used as a surface material, the laminate wood flooring is sensitive to moisture, has a very brittle surface, and provides coldness to users. Furthermore, if sharp or heavy objects having an excessive weight drop thereon, the laminate wood flooring exhibits partial damage, such as breakage, indentation, etc., and the surface of the laminate wood flooring provided with an artificial printing pattern suffers from considerable deterioration in the natural texture of raw lumber as compared to the above described wood flooring for an under-floor heating system containing the water-resistant plywood.

### DISCLOSURE

### Technical Problem

Therefore, the present invention has been made in view of the above problems of the conventional wood floorings, and it is an object of the present invention to provide a wood flooring which comprises a high-density fiberboard base layer for achieving an outstanding improvement in surface physical properties, such as impact-resistance and indentation-resistance, etc., and also comprises a natural laminated wood layer stacked on the base layer for providing the flooring surface with the natural texture of raw lumber.

It is another object of the present invention to provide a wood flooring which comprises a high-density fiberboard base layer and an upper laminated wood layer and lower laminated wood or veneer layer symmetrically stacked at upper and lower sides of the high-density fiberboard base layer to achieve a stable structure, the lower laminated wood or veneer layer having a density of 100±30% of that of the upper laminated wood layer to keep the balance therebetween, thereby completely eliminating deformation problems caused by variation of environmental conditions, such as temperature, humidity, etc., while preventing damage to the flooring surface, for example, indentation, breakage, scratching, etc. caused by sharp or heavy objects by virtue of glass pieces, ceramic, nano-inorganic material, silica, etc. added in a treated surface layer of the wood flooring to achieve an outstanding improvement in surface physical properties, such as scratch-resistance, etc.

It is yet another object of the present invention to a process for manufacturing a wood flooring, which can completely eliminate problems of deformation, such as distortion, that is caused when a laminated wood layer, high-density fiberboard layer and balance layer (made of laminated wood or veneer) are integrated to one another under predetermined conditions, and can achieve improvements of workability and productivity in the integration of wood and high-density fiberboard.

### Technical Solution

In accordance with an aspect of the present invention, the above and other objects can be accomplished by the provision of a wood flooring comprising a balance layer, a first adhesive layer, a high-density fiberboard (HDF) layer, a second adhesive layer and a laminated wood layer stacked in this order from the bottom, wherein the upper layers and the lower layers are symmetric with respect to the high-density fiberboard layer.

To maximize the balancing effect by the symmetric structure, a laminated wood or veneer having a density of 100±30% of that of the laminated wood layer forming an upper layer may be stacked below the high-density fiberboard layer forming a base layer.

The wood flooring of the present invention is cheaper than conventional wood floorings and has good dimensional stability and moisture-resistance. Further, with a configuration in that the laminated wood layer and balance layer are integrated to the high-density fiberboard base layer, the wood flooring of the present invention has significantly improved superior indentation-resistance and impact-resistance as compared to a conventional water-resistant plywood flooring for an under-floor heating system and also, has good insulation of sound and absorption of walking impact and is advantageous to reduce the consumption of energy because of a high heat conductivity thereof.

The greatest advantage of the wood flooring containing the laminated wood layer according to the present invention is to realize superior natural texture of raw lumber as compared to a conventional laminate wood flooring comprising a printing layer and melamine-impregnated overlay sheet laminated on a high-density fiberboard base layer. The wood flooring of the present invention has good impact-resistance and provides warm visual feeling to the consumer.

Generally, a high-density fiberboard has symmetric materials and physical properties in respective directions to maintain the good balancing effect. However, if a laminated wood layer is stacked only at an upper surface of the high-density fiberboard, the high-density fiberboard may be deformed by unbalance of natural tension that is caused by a difference of moisture contents of upper and lower portions of the high-density fiberboard. In consideration of this problem, in the present invention, another laminated wood or veneer layer, which has a density of 100±130% of that of the upper laminated wood layer, is stacked underneath the high-density fiberboard base layer to balance the upper laminated wood layer, so as to achieve a stable structure. This has the effect of completely eliminating deformation problems caused by variation of environmental conditions such as temperature, humidity, etc.

Preferably, the balance layer may be formed of the laminated wood or veneer having a density of 100±30% of that of the upper laminated wood layer, to have a symmetric structure with the upper laminated wood layer.

Preferably, each of the first adhesive layer and the second adhesive layer is formed of a water-based or solvent-free adhesive to improve productivity and workability while minimizing the contamination of environment. The adhesive may be selected from epoxy-based resins, polyurethane-based resins, polyisocyanate-based resins, polyester-based resins, acrylate-based resins, ethylene-vinyl acetate copolymer resins, polyamide-based resins, melamine-based resins, and synthetic rubber-based resins, and in particular, may be a melamine-based adhesive.

To improve the workability and adhesive force, etc., the first and the second adhesive layers may include at least one of wheat flour, starch, soybean flour, etc. as well as at least one of antimicrobial agents, antiseptic agents, etc.

The wood flooring may further comprise a backside waterproof layer stacked underneath the balance layer, and the backside waterproof layer may be produced by coating at least one of a UV-setting surface treatment agent, a thermosetting surface treatment agent, synthetic resins, waxes, a silicone-based water repellent, a silicone-based moisture repellent, etc.

The wood flooring may further comprise a surface coating layer stacked on the laminated wood layer. The surface coating layer includes a primer layer, a lower coating layer, an intermediate coating layer, and an upper coating layer stacked in this order from the bottom. The primer layer may include water-based acryl having a molecular weight in a range from 100,000 to 200,000. If the lower and the upper coating layers include inorganic materials, such as ceramic, glass chops, clay, silica, and the like, surface physical properties of the wood flooring, such as scratch-resistance, etc., are improved and thus, there is no risk of damage to the flooring surface, such as indentation, breakage, scratch, etc. by heavy or sharp objects.

The wood flooring may have a tongue and groove (T & G) structure, click system, or connection structure using connectors for the interconnection of sectional wood floorings.

In accordance with another aspect of the present invention, the above and other objects can be accomplished by the provision of a process for manufacturing a wood flooring comprising: preparing a laminated wood layer, a high-density fiberboard layer, and a balance layer; producing a first adhesive layer and a second adhesive layer about the high-density fiberboard layer; and stacking the balance layer, the first adhesive layer, the high-density fiberboard layer, the second adhesive layer and the laminated wood layer in this order from the bottom and integrating them with one another by thermal compression.

Preferably, the process may further comprise: producing a surface coating layer on the laminated wood layer, wherein the surface coating layer includes a primer layer, a lower coating layer, an intermediate coating layer, and an upper coating layer stacked in this order from the bottom; producing a backside waterproof layer underneath the balance layer; and cutting and shaping a stack of the layers.

The adhesion and stacking of the respective layers may be performed by one of the following methods. Specifically, firstly, the first and the second adhesive layers may be produced and stacked at opposite surfaces of the high-density fiberboard layer. Secondly, the first and the second adhesive layers are produced and stacked, respectively, on the balance layer and high-density fiberboard layer. Thirdly, after the first adhesive layer is produced at a side of the high-density fiberboard layer to stack the balance layer thereon, the second adhesive layer may be produced at an opposite side of the high-density fiberboard layer to stack the laminated wood layer thereon.

Preferably, in consideration of anti-deformation of products and improvement of productivity, the thermal compression may be performed under conditions including a temperature of 80˜160° C., a pressure of 0.1˜1.0 Mpa, and a time of 5 seconds to 5 minutes.

Preferably, in consideration of surface physical properties, the primer layer may be produced by curing at a temperature of 80˜150° C. after the lapse of 10 seconds to 4 minutes from its coating time point.

### DESCRIPTION OF DRAWINGS

The above and other objects, features and other advantages of the present invention will be more clearly understood from the following detailed description taken in conjunction with the accompanying drawings, in which:

FIG. 1 is a sectional view of a wood flooring according to a first embodiment of the present invention;

FIG. 2 is a sectional view of a wood flooring according to a second embodiment of the present invention;

FIG. 3 is a process view showing the manufacture of the wood flooring according to the first embodiment of the present invention;

FIG. 4 is a process view showing the manufacture of the wood flooring according to the second embodiment of the present invention; and

FIG. 5 is a plan view illustrating a finished wood flooring product having a tongue and groove (T & G) structure according to the present invention.

### DESCRIPTION OF REFERENCE NUMERALS TO IMPORTANT PARTS OF THE DRAWINGS

10: surface coating layer
20: laminated wood layer
30: second adhesive layer
40: high-density fiberboard (HDF) layer
50: first adhesive layer
60: balance layer
70: backside water-proof layer
80: tongue
90: groove

### BEST MODE

Now, the present invention will be described in detail with reference to the accompanying drawings.

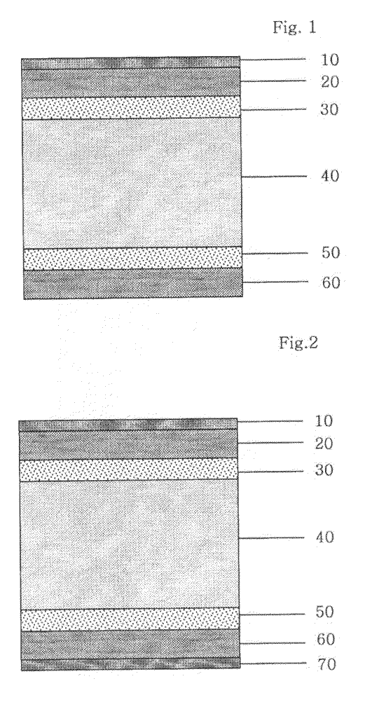

FIG. 1 is a sectional view of a wood flooring according to a first embodiment of the present invention. The wood flooring includes a balance layer 60, first adhesive layer 50, high-density fiberboard layer 40, second adhesive layer 30, laminated wood layer 20, and surface coating layer 10 stacked in this order from the bottom. The laminated wood layer 20 and balance layer 60 are stacked at upper and lower sides of the high-density fiberboard layer 40 serving as a base layer, to have a symmetric structure.

FIG. 2 is a sectional view of a wood flooring according to a second embodiment of the present invention. In the present embodiment, in addition to subjecting an upper surface of the laminated wood layer 20 to a surface coating treatment for the sake of improving water-resistance, a lower surface of the balance layer 60 is coated with UV-setting or thermosetting surface coating material containing urethane acrylate as a main component, or coated with at least one selected from synthetic resins, such as polyolefine, polyester, etc., waxes, silicone-based water repellents and silicone-based moisture repellents. The resulting coating layer is able to prevent the balance layer 60 from being spoiled or deformed by moisture permeated into the balance layer 60.

A laminated wood used to constitute the laminated wood layer 20 is used to create the natural texture of raw lumber and may be selected, in accordance with the consumer's requirements, from all species of trees commonly used, such as oak, birch, cherry, maple, walnut, etc.

Conventionally, the laminated wood is obtained by slicing raw lumber, and more particularly, cutting the raw lumber by use of a rotary lathe or slicer, to produce a wet laminated wood having a thickness of 0.15˜0.35 mm or dried laminated wood having a thickness of 0.35˜1.0 mm.

To achieve improvements in water-resistance and hardness as occasion demands, the laminated wood may be produced by impregnating a natural laminated wood with a resin selected from urea, urea-melamine, melamine, phenol, acryl, polyester, unsaturated polyester, epoxy, polyvinyl-acetate, and urethane resins under a reduced pressure by an injection technique, and then drying and semi-curing the resin-impregnated laminated wood in an oven at a temperature 80˜150° C. for 20 seconds to 4 minutes. In the impregnation step, the natural laminated wood is impregnated in 30˜150 parts by weight of the resin on the basis of the weight thereof.

A high-density fiberboard (HDF) used to constitute the high-density fiberboard layer 40 preferably has a specific gravity of 0.85˜1.1 g/cm³. The high-density fiberboard is significantly harder than a medium-density fiberboard (MDF) or particle board (PB), and has good water-resistance and dimensional stability as well as a high mechanical strength. Therefore, when using the high-density fiberboard to constitute a base layer of the wood flooring, the wood flooring can achieve considerable improvements in dimensional stability, impact-resistance strength and moisture-resistance in use.

The HDF has lower costs as well as higher wear-resistance and impact-resistance than a water-resistant plywood and also, exhibits no defects, such as knots. Further, since fibers thereof are uniformly arranged in respective directions, the HDF has uniform physical properties. Furthermore, since the HDF can be easily processed and achieve a very smooth and soft surface after being processed, the wood flooring manufactured using the HDF offers a smooth surface and is soft to the touch. The wood flooring using the HDF may realize an integrated mechanical coupling system achieving a vertical or horizontal coupling, a click construction structure, or a connection structure using connectors. Also, since the HDF is elastically expandable and constrictable, there is no risk of unintentional release in the coupling of sectional wood floorings or damage thereto.

The balance layer 60 is stacked at the lower side of the high-density fiberboard layer 40 to maximize the balancing effect using a symmetric structure. Although the balance layer 60 may be made of a laminated wood to provide the flooring product with a luxurious outer appearance, it is preferable that, unless the laminated wood does not belong to species of trees forming the outer appearance of a construction, the balance layer be made of a veneer that is cheaper than the laminated wood constituting the upper layer of the wood flooring and has a density of 100±30% of that of the upper laminated wood layer and good dimensional stability.

The veneer may be formed of tropical wood that is autogenous in Southeast Asia regions, and more particularly, may be produced by cutting raw lumber by use of a rotary lathe or slicer, drying the cut wood to have a moisture content of 10% or less, and processing the resulting wood to have a predetermined size and a thickness of 0.3˜1.0 mm suitable to maximize the balancing effect of the wood flooring.

By stacking the laminated wood or veneer layer at the lower side of the high-density fiberboard base layer to be symmetric to the upper laminated wood layer, the wood flooring of the present invention can have a stable structure in which the upper and lower layers keep the balance about the base layer.

The first adhesive layer 50 and second adhesive layer 30 are used to integrate the high-density fiberboard layer 40 with the balance layer 60 and laminated wood layer 20, respectively. Examples of an adhesive for use in the first and the second adhesive layers include epoxy-based, polyurethane-based, polyisocyanate-based, polyester-based, acrylate-based ethylene-vinyl acetate copolymers, polyamide-based, thermosetting melamine-based, synthetic rubber-based resins, etc., and more preferably, the adhesive may be a melamine-based adhesive.

A solvent type adhesive that had been widely used in general has not been allowed recently by rigid regulations related to volatile organic compounds (VOCs) and because it may cause so-called “sick house syndrome”. For this reason, recently, a water-based adhesive considered as an environmentally friendly adhesive has been used to substitute for the solvent type adhesive, but the water-based adhesive may cause peeling of the high-density fiberboard due to a rapid reduction in the moisture content of wood when the laminated wood or balance layer is stacked on the high-density fiberboard layer by thermal compression. In conclusion, the most preferable adhesive is a solvent-free type adhesive, which can cause the emission of formaldehyde to be zero, prevent the generation of volatile organic solution, and considerably reduce a process time required to adhere and integrate the laminated wood to the high-density fiberboard, for example, from 1 hour to 5 minutes or less, resulting in outstanding improvements in dimensional stability, productivity and workability.

In the present invention, wheat flour, starch, extracted soybean flour, or combinations thereof may be added to the adhesive. Of these additives, wheat flour and starch are preferable and in particular, wheat flour is more preferable. In view of an increase in workability and adhesive force, it is advantageous to add the additives, in particular, wheat flour in an amount of 0.1˜50 parts by weight and preferably, 25 parts by weight or less, on the basis of 100 parts by weight of a synthetic resin. These additives, in particular, wheat flour serves not only to thicken the adhesive, but also to improve water-resistance of the adhesive, and causes the adhesive to show no adhesive force in cold water, but to have a strong adhesive force upon receiving heat. Preferably, the wheat flour is added at the final stage of mixing of the adhesive and, when adding the wheat flour in an amount of 10 parts by weight or more, the wheat flour may be divided and added little by little for the sake of preventing coagulation.

In addition to the above mentioned additives, an antimicrobial or antiseptic agent may be added to the adhesive to exhibit good sterilizing and anti-bacterial effects against microorganisms, in particular, bacteria and mold contained in a wood and adhesive. Although the antimicrobial or antiseptic agent, etc. may be added to an amount of 0.01˜10 parts by weight on the basis of 100 parts by weight of the adhesive, it is preferable to add the antimicrobial or antiseptic agent in an amount of 2.0 parts by weight or less in order to prevent a variation in physical properties of the adhesive. Examples of the antimicrobial or antiseptic agent may include isothiazoline-based compounds and derivatives thereof, sodium-bisulfite, peroxide, periodic acid and derivatives thereof, halogen-based compounds including chlorine and bromine based compounds, and the like.

The surface coating layer 10 is a finishing layer produced by subjecting the upper surface of the laminated wood layer 20 to a surface coating treatment. The surface coating layer generally includes, from the bottom, a primer, lower, intermediate and upper coating layers.

The primer layer is produced by curing a monomer and oligomer having a relatively low molecular weight at a temperature of 80˜150° C. to achieve an increase in impact-resistance and indentation-resistance. The primer layer serves to allow a coating paint to be more easily and deeply permeated into the laminated wood layer. Preferably, the primer layer is cured after the lapse of 10 seconds to 4 minutes from its time of coating.

The lower coating layer may include inorganic material, such as glass chops, etc. to achieve an improvement in surface physical properties, and the addition amount to the lower coating layer is preferably in a range of 0.1˜10% by weight.

The upper coating layer may include nano-inorganic material, silica, etc. to achieve an increase in surface scratch-resistance and wear-resistance, and the addition amount to the upper coating layer is preferably in a range of 0.1˜10% by weight.

The backside waterproof layer 70 is stacked underneath the balance layer 60 to achieve an increase in water-resistance. The backside waterproof layer 70 is produced by coating UV-setting or thermosetting surface treatment material containing urethane acrylate as a main component, or by coating at least one selected from synthetic resins, such as polyolefine, polyester, etc., waxes, silicone-based water repellents and silicone-based moisture repellents, and serves to prevent the balance layer 60 from being spoiled or deformed by moisture permeated into the balance layer 60.

Although it is preferable that the wood flooring of the present invention is processed to have a general tongue and groove (T & G) structure in a finished product state in consideration of ease in assembling, the wood flooring may have an integrated mechanical coupling system achieving a vertical or horizontal coupling, for example, click construction structure, or connection structure using connectors.

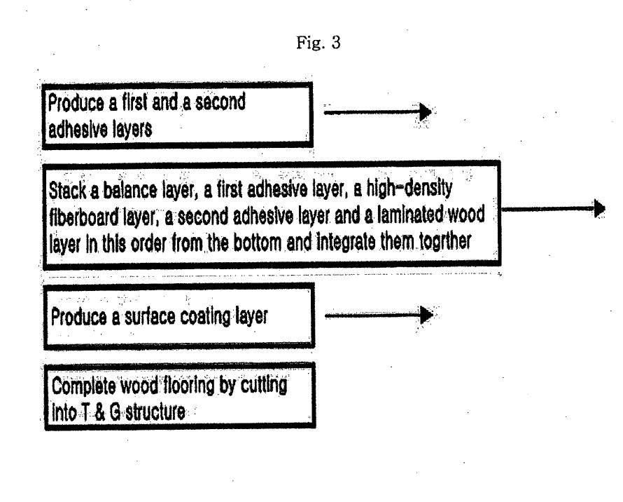

FIG. 3 is a process view showing the manufacture of the wood flooring according to the first embodiment of the present invention. The process for manufacturing the wood flooring according to the first embodiment comprises: a first step of providing the first adhesive layer 50 and second adhesive layer 30, respectively, between the high-density fiberboard layer 40 and the balance layer 60 and between the high-density fiberboard layer 40 and the laminated wood layer 20; a second step of stacking the balance layer 60, first adhesive layer 50, high-density fiberboard layer 40, second adhesive layer 30 and laminated wood layer 20 in this order from the bottom and thermally compressing them together; a third step of subjecting the upper surface of the laminated wood layer 20 to a surface coating treatment; and a fourth step of cutting and shaping the resulting stack.

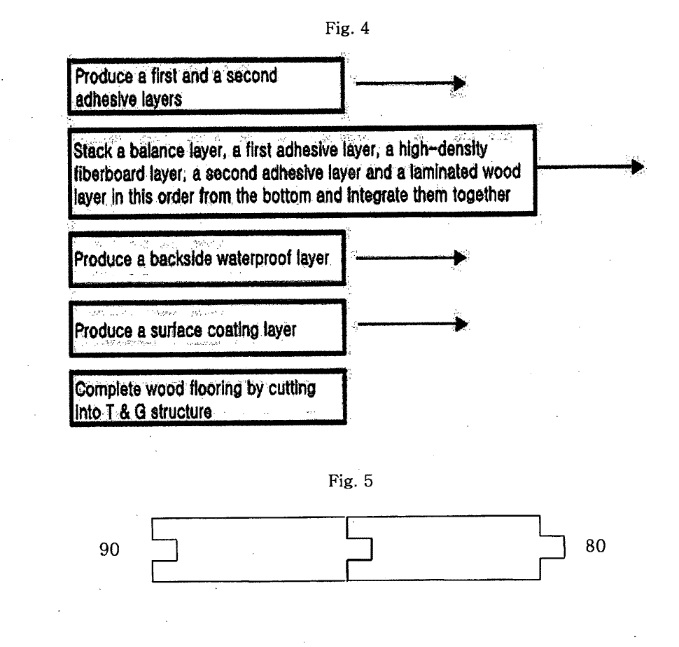

FIG. 4 is a process view showing the manufacture of the wood flooring according to the second embodiment of the present invention. In addition to the process of FIG. 3, the process of the present embodiment further comprises a step of producing the backside waterproof layer 70 underneath the balance layer 60.

In the integration step, i.e. the second step of the above described process, a thermal compression temperature is preferably in a range of 80˜160° C. If the thermal compression temperature is excessively high, it causes an excessive expansion of the high-density fiberboard. In this case, after a press is removed, the finished product may exhibit excessive deformation as a temperature thereof reaches a room temperature. Conversely, if the thermal compression temperature is excessively low, it may cause poor adhesion due to an insufficient curing of the adhesive and consequently, undesirable surface leveling results even if the adhesion is achieved.

Preferably, a thermal compression pressure is in a range of 0.1˜1.0 Mpa. An excessively high thermal compression pressure may cause breakage of the laminated wood or balance layer, whereas an excessively low thermal compression pressure may cause poor adhesion.

Also, a thermal compression time is preferably in a range of 5 seconds˜5 minutes. An excessively short thermal compression time may cause poor adhesion due to an insufficient curing of the adhesive, whereas an excessively long thermal compression time may cause breakage or discoloration of the laminated wood or balance layer.

In the above described first step, examples of a method for producing the first adhesive layer 50 and second adhesive layer 30 include a first method for producing the first and the second adhesive layers 50 and 30 at opposite surfaces of the high-density fiberboard layer 40, a second method for producing the first adhesive layer 50 on the balance layer 60 and the second adhesive layer 30 on the high-density fiberboard layer 40, respectively, and a third method for producing the first adhesive layer 50 at a lower surface of the high-density fiberboard layer 40, prior to stacking the balance layer 60 underneath the high-density fiberboard layer 40 and integrating them with each other by thermal compression, and producing the second adhesive layer 30 at an upper surface of the high-density fiberboard layer 40 stacked with the balance layer 60, prior to stacking the laminated wood layer 20 above the high-density fiberboard layer 40 and integrating them with each other by thermal compression.

In this case, examples of the adhesive may include thermosetting melamine resin, thermosetting or room-temperature setting urethane, epoxy resin, polyvinyl-alcohol, polyvinyl-acetate, acrylate, and the like. When using the room-temperature setting adhesive, the laminated wood layer, balance layer and base layer may be adhered to one another if they are compressed by a pressure of 0.1˜1.0 Mpa at a temperature of not exceeding 40° C. When using the thermosetting adhesive, the laminated wood layer, balance layer and base layer may be adhered to one another if they are thermally compressed by a pressure of 0.1˜1.0 Mpa and a temperature of 80˜160° C. for 5 seconds˜5 minutes.

The wood flooring of the present invention has a stable structure in which the upper and lower layers are balanced with each other about the base layer and therefore, has no necessity for cold compression that is conventionally performed to prevent deformation of the wood flooring. If the wood flooring is thermally compressed at a high temperature for a long time, the moisture content of wood rapidly decreases and the resulting wood flooring product is likely to be deformed. Therefore, a reduction in the thermal compression time has the effect of improving productivity and preventing deformation of products.

The surface coating layer 10 is produced on the laminated wood layer 20 that is in a semi-finished product state obtained by the above described integration step. A surface coating treatment for achieving the surface coating layer 10 is performed in the same manner as a conventional wood panel production process. Specifically, the upper surface of the laminated wood layer 20 is first subjected to sanding, to facilitate permeation of a coating paint or other foreign substances. Then, primer, lower, intermediate and upper coating layers are coated in this order from the upper surface of the laminated wood layer 20, followed by being cured.

The surface coating layer 10 is made of a UV-setting or thermosetting synthetic resin containing urethane acrylate as a main component. Preferably, the surface coating layer 10 is made of at least one resin selected from a group consisting of epoxy, polyamide, urea, acrylate resins, and more preferably, made of epoxy resin.

To achieve an increase in surface impact-resistance and indentation-resistance, the primer layer is produced by curing an oil-based or water-based monomer and low-molecular weight oligomer at a temperature of 80˜150° C. With the use of the primer layer, a coating paint can be more easily and deeply permeated into the laminated wood layer. In this case, the primer layer is preferably cured after the lapse of 10 seconds to 4 minutes from its time of coating.

The lower coating layer may include any inorganic material, such as ceramic, glass chops, etc., and the amount of the inorganic material is preferably in a range of 0.1˜10% by weight. To achieve an improvement in surface scratch-resistance, the upper coating layer may include at least one selected from inorganic material, such as clay mineral, silica, etc., and nano-inorganic material. Also, to have no influence on the appearance of the flooring, preferably, the inorganic or nano-inorganic material in an amount of 0.1˜10 parts by weight on the basis of 100 parts by weight of the urethane acrylate resin is added while being sufficiently distributed.

FIG. 5 is a plan view illustrating a finished wood flooring product having a tongue and groove (T & G) structure according to the present invention. In accordance with the above described manufacturing process, for example, two tongues 80 and two grooves 90 may be formed at four sides of the wood flooring in longitudinal and width directions, respectively, as shown in FIG. 5, to provide the wood flooring with a T & G outer profile, and may be processed by use of a click system, connection system using connectors, or integrated mechanical coupling system achieving a vertical or horizontal coupling.

Hereinafter, preferred examples of the present invention are described. It should be understood that the following examples simply exemplify the present invention, and the present invention is not limited to the following examples.

### Example 1

After producing the first adhesive layer 50 and second adhesive layer 30 at opposite surfaces of the high-density fiberboard layer 40, the balance layer 60, first adhesive layer 50, high-density fiberboard layer 40, second adhesive layer 30, and laminated wood layer 20 were laminated in this order from the bottom, and thermally compressed to be integrated with one another. Subsequently, the upper surface of the laminated wood layer 20 was subjected to a surface coating treatment to produce the surface coating layer 10, followed by cutting and shaping to provide the wood flooring with the tongues 80 and grooves 90 defining a T & G outer profile. In this way, the wood flooring as shown in FIG. 1, which includes the laminated wood and high-density fiberboard using a symmetric structure, was manufactured.

In the present example, the laminated wood layer 20 was formed of a laminated wood having a thickness of 0.35˜0.55 mm, a moisture content of 12% or less, and a density of 400˜600 kg/m³. The balance layer 60 was formed of a veneer having a thickness of 0.30˜0.60 mm, a moisture content of 12% or less, and a density of 350˜650 kg/m³. The base layer 40 was formed of an HDF having a thickness of 7.5˜8.0 mm, a moisture content of 4.0˜7.0%, and a density of 900 kg/m³ or more.

The first and the second adhesive layers 50 and 30 were formed of a water-based or solvent-free type thermosetting melamine-based adhesive, and were integrated to the relevant layers under predetermined thermal compression conditions, for example, a temperature of 100˜140° C., a pressure of 0.6 Mpa, and a time of 10 seconds˜1 minute.

Also, the surface of the integrated laminated wood layer was subjected to sanding, and primer, lower and intermediate coating layers were coated on the surface of the laminated wood layer in this order. After completing the coating of the lower coating layer while adding 5 parts by weight of ceramic into the lower coating layer, the resultant semi-finished wood flooring was cut by use of a tenoner to have a width of 85˜95 mm and a length of 850˜950 mm. Thereafter, the side surfaces of the cut sectional wood flooring were formed with the tongues and grooves to have a T & G structure. Finally, an upper coating layer including 5% by weight of nano-inorganic material, was applied to obtain a finished product.

### Example 2

The present example is equal to the Example 1 except for the fact that the backside waterproof layer 70 was produced underneath the balance layer 60 by coating a UV-setting coating layer, to manufacture the wood flooring including the laminated wood and high-density fiberboard using a symmetric structure as shown in FIG. 2.

### Example 3

The present example is equal to the Example 1 except for the fact that the balance layer 60 was formed of a laminated wood instead of the veneer.

### Example 4

The present example is equal to the Example 1 except for the fact that the upper coating layer included glass chops instead of the nano-inorganic material.

### Example 5

The present example is equal to the Example 1 except for the fact that the upper coating layer included silica instead of the nano-inorganic material.

### Comparative Example 1

The present example is equal to the Example 1 except for the fact that no layer was laminated underneath the high-density fiberboard layer 40 serving as a base layer.

### Comparative Example 2

There was used a plywood flooring comprising a water-resistant plywood base layer and a natural laminated wood stacked on the plywood, the plywood flooring being subjected to a UV-setting surface coating treatment.

### Comparative Example 3

There was used a laminate wood flooring comprising a high-density fiberboard (HDF) base layer and a melamine resin surface layer stacked on the HDF layer.

[Tests]

Physical properties of the wood floorings obtained by the Examples 1 to 5 were compared with those of the Comparative Examples 1 to 3, and the results are shown in the following Table 1.

TABLE 1

| | | | | | | | | Absorptive | |
|---|---|---|---|---|---|---|---|---|---|
| | | | | | | | | Thickness | |
| | | | Dimensional Stability % | | | | | Expansion | |
| | | Brittle- | Heating | | Impregnation | | | U- | M- |
| Classification | Indentation | ness | L | W | L | W | Scratch | type | type |
| Example 1 | 15 cm | 50 cm | −0.2 | −0.35 | 0.07 | 0.11 | 5N | 2.5% | 30% |
| Example 2 | 15 cm | 50 cm | −0.2 | −0.35 | 0.07 | 0.11 | 5N | 2.0% | 25% |
| Example 3 | 15 cm | 50 cm | −0.2 | −0.35 | 0.07 | 0.11 | 5N | 2.5% | 30% |
| Example 4 | 15 cm | 50 cm | −0.2 | −0.35 | 0.07 | 0.11 | 5N | 2.5% | 30% |
| Example 5 | 15 cm | 50 cm | −0.2 | −0.35 | 0.07 | 0.11 | 5N | 2.5% | 30% |
| Comparative | 15 cm | 45 cm | −0.30 | −0.38 | 0.08 | 0.13 | 5N | — | — |
| Example 1 | | | | | | | | | |
| Comparative | 10 cm | 20 cm | −0.15 | −0.21 | 0.05 | 0.23 | 3N | — | — |
| Example 2 | | | | | | | | | |
| Comparative | 10 cm | 35 cm | −0.37 | −0.42 | 0.08 | 0.15 | 4N | 2.5% | 50% |
| Example 3 | | | | | | | | | |

In Table 1, the surface indentation was represented by a drop height causing a damage to a surface of the wood flooring as a test target object. The drop height was measured by dropping a flat head screwdriver weighing 110 g on an inclined surface of the wood flooring that has an inclination angle of 45° with a horizontal plane. As can be understood from the measured results stated in the Table 1, the conventional laminate wood flooring (Comparative Example 3) and plywood flooring for an under-floor heating system (Comparative Example 2) acquired indented marks at their surface when dropping the flat head screwdriver at a height of 10 cm, whereas the wood flooring of the present invention (Examples 1 to 5 and Comparative Example 1) acquired indented marks when dropping the screwdriver at a height of 15 cm.

In Table 1, the surface brittleness was represented by a drop height causing a crack to a surface of the wood flooring as a test target object. The drop height was measured by vertically dropping a metal ball having a diameter of 3 cm and a weight of 228 g on the surface of the wood flooring. In accordance with the measured results in the Table 1, the conventional laminate wood flooring (Comparative Example 3) and plywood flooring for an under-floor heating system (Comparative Example 2) acquired cracks at their surface when dropping the metal ball at heights of 35 cm and 20 cm, respectively, whereas the wood flooring of the present invention (Examples 1 to 5 and Comparative Example 1) acquired cracks when dropping the metal ball at a height of 50 cm.

In Table 1, the dimensional stability was represented by dimensional variation rates in length (L) and width (W), which were measured after leaving the wood flooring as a test target object in an oven having a temperature of 80° C. and then, impregnating the heated wood flooring in a room-temperature water vessel for 24 hours. In accordance with the measured results stated in the Table 1, the dimensional stability of the wood flooring according to the present invention is slightly inferior to the conventional plywood flooring for an under-floor heating system, but is considerably superior to the conventional laminate wood flooring.

In Table 1, the scratch was represented by a load causing a surface scratch, which was measured by use of a Clemens type scratch hardness tester based on a method disclosed in a regulation in section 3.15, KS M3332. In accordance with the measured results in the Table 1, the wood flooring of the present invention revealed scratch-resistance (as high as 5.0N) that is superior to 2.0N of the plywood flooring for an under-floor heating system and 1.0N of the conventional reinforced laminate wood flooring.

In Table 1, the absorptive thickness expansion was represented by a thickness variation rate, which was measured by impregnating the wood flooring with room-temperature water for 24 hours (U-type, based on a regulation in section 6.9, KS F3200), or impregnating the wood flooring with warm water having a temperature of 70° C. for 2 hours (M-type). In accordance with the measured results in the Table 1, in the case of U-type impregnation, the wood flooring of the present invention revealed the absorptive thickness expansion of 2.5%, which is equal to that of the conventional reinforced wood flooring. However, in the case of M-type impregnation, the wood flooring of the present invention revealed the absorptive thickness expansion of 30%, which is superior to 50% of the conventional reinforced wood flooring.

Also, the wood floorings of the Example 1 and Comparative Examples 1 to 3 were compared in warp stability, and the results are described in the following Table 2.

TABLE 2

Warp Stability

| Classification | Width (mm) | Length (mm) |
|---|---|---|
| Example 1 | 0.03 | 2.21 |
| Comparative Example 1 | 1.62 | 16.56 |
| Comparative Example 2 | 0.05 | 5.77 |
| Comparative Example 3 | 0.08 | 0.96 |

The warp stability of Table 2 was represented by dimensions of curls and domes generated after leaving samples in an oven having a temperature of 80±2° C. for 24 hours. In accordance with the measured results, the wood flooring of the present invention revealed the most superior warp stability in the width direction thereof, and the warp stability in the longitudinal direction of the wood flooring according to the present invention was 2.21 mm, which is slightly inferior to 0.96 mm of the conventional reinforced wood flooring (Comparative Example 3), but is considerably superior to 5.77 mm of the plywood flooring (Comparative Example 2) and 16.56 mm of the flooring having no balance layer (Comparative Example 1).

As can be appreciated by analyzing the above experimental results, the wood flooring of the present invention has surface physical properties superior to those of the conventional plywood flooring and laminate wood flooring against surface indentation or damage by sharp or heavy objects, and has a symmetric structure effective in keeping the balance thereof.

### INDUSTRIAL APPLICABILITY

As apparent from the above description, the present invention provides a wood flooring comprising a high-density fiberboard base layer and an upper laminated wood layer and lower laminated wood or veneer layer symmetrically stacked at upper and lower sides of the high-density fiberboard base layer to achieve a stable structure, the lower laminated wood or veneer layer having a density of 100±30% of that of the upper laminated wood layer to keep the balance therebetween. With this configuration, the wood flooring can completely eliminate deformation problems caused by variation of environmental conditions such as temperature, humidity, etc., and can realize the natural texture of raw lumber.

Further, the wood flooring of the present invention comprises a surface coating layer including two or more elements selected from inorganic materials, such as glass chops, ceramic, clay, silica, etc. and nano-inorganic materials, thereby achieving outstanding improvements in surface physical properties, such as impact-resistance, indentation-resistance, scratch-resistance, etc. Also, by virtue of an improved heat-transfer ability as well as good dimensional stability and durability, the wood flooring of the present invention can achieve a remarkable reduction in the consumption of energy and is usable even in poor environmental conditions.

Furthermore, the wood flooring of the present invention has a dimensional stability superior to a conventional laminate wood flooring, and can exhibit the natural texture of raw lumber as a result of constituting a surface layer thereof with a laminated wood. In particular, since the wood flooring has a structure in which the upper laminated wood layer and lower balance layer are symmetrically stacked about the base layer to maximize the balancing effect, the wood flooring of the present invention can exclude a cold compressing operation from its integration step, and achieve considerable improvements in dimensional stability, productivity and workability.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A wood flooring comprising a balance layer, a first adhesive layer, a high-density fiberboard layer (HDF), a second adhesive layer and a laminated wood layer stacked in this order from the bottom, wherein the upper layers and the lower layers are symmetric with respect to the high-density fiberboard layer.

2. The flooring according to claim 1, wherein the balance layer is formed of a laminated wood or a veneer having a density of 100±30% of that of the laminated wood layer.

3. The flooring according to claim 1, wherein each of the first adhesive layer and the second adhesive layer is formed of a water-based or solvent-free adhesive, which is selected from epoxy-based resins, polyurethane-based resins, polyisocyanate-based resins, polyester-based resins, acrylate-based resins, ethylene-vinyl acetate copolymer resins, polyamide-based resins, melamine-based resins, and synthetic rubber-based resins.

4. The flooring according to claim 1, wherein each of the first adhesive layer and the second adhesive layer includes at least one of wheat flour, starch and soybean flour.

5. The flooring according to claim 1, wherein each of the first adhesive layer and the second adhesive layer includes at least one of antimicrobial agents and antiseptic agents.

6. The flooring according to claim 1, further comprising a backside waterproof layer stacked underneath the balance layer.

7. The flooring according to claim 6, wherein the backside waterproof layer is produced by coating at least one of a UV-setting surface treatment agent, a thermosetting surface treatment agent, synthetic resins, waxes, a silicone-based water repellent, and a silicone-based moisture repellent.

8. The flooring according to claim 1, further comprising a surface coating layer stacked on the laminated wood layer, wherein the surface coating layer includes a primer layer, a lower coating layer, an intermediate coating layer, and an upper coating layer stacked in this order from the bottom.

9. The flooring according to claim 8, wherein the primer layer includes water-based acryl having a molecular weight in a range from 100,000 to 200,000.

10. The flooring according to claim 8, wherein each of the lower coating layer and the upper coating layer includes inorganic materials.

11. The flooring according to claim 10, wherein the inorganic materials include at least one selected from ceramic, glass chops, clay and silica.

12. The flooring according to claim 1, wherein the wood flooring has a tongue and groove (T & G) structure, a click system, or a connected structure using connectors.

13. A process for manufacturing a wood flooring comprising:
preparing a laminated wood layer, a high-density fiberboard layer, and a balance layer;
producing a first adhesive layer and a second adhesive layer about the high-density fiberboard layer; and
stacking the balance layer, the first adhesive layer, the high-density fiberboard layer, the second adhesive layer and the laminated wood layer in this order from the bottom and integrating them with one another by thermal compression.

14. The process according to claim 13, further comprising:
producing a surface coating layer on the laminated wood layer, wherein the surface coating layer includes a primer layer, a lower coating layer, an intermediate coating layer, and an upper coating layer stacked in this order from the bottom;
producing a backside waterproof layer underneath the balance layer; and
cutting and shaping a stack of the layers.

15. The process according to claim 13, wherein the thermal compression is performed under conditions of a temperature of 80˜160° C., a pressure of 0.1˜1.0 Mpa, and a time of 5 seconds to 5 minutes.

16. The process according to claim 14, wherein the primer layer is cured at a temperature of 80˜150° C. after the lapse of 10 seconds to 4 minutes from its time of coating.
